(19) United States
(12) Patent Application Publication
(10) Pub. No.: US 2006/0236110 A1
(43) Pub. Date: Oct. 19, 2006

(54) Method, device and computer program for verifying the authenticity of non-electronic documents

(76) Inventor: Peter Schaub, Munchen (DE)

Correspondence Address: Siemens Corporation;Intellectual Property Department, 170 Wood Avenue South, Iselin, NJ, 08830, US

(21) Appl. No.: 10/506,086

(22) PCT Filed: Feb. 25, 2003
(86) PCT No.: PCT/DE03/00612

§ 371 Date: May 9, 2005

(51) Int. Cl. H04L 9/00

(52) U.S. Cl. 713/176

(57) ABSTRACT

The invention relates to a method for examining the authenticity of non-electronic documents, whereby a non electronic document comprises a document identifier, text and/or graphic user information, at least implicit information on the document user and a signature which is a coded first test code calculated by means of a test function from the document identifier and the text and/or graphic user information. According to the invention, the document identifier, the text and/or graphic user information and the signature are scanned. A second test code is calculated from the scanned document identifier and the scanned text and/or graphic user information by means of the test function. The scanned signature is decoded in order to determine the first test code by using the at least implicit information on the document user. The first and second test codes are compared for consistency.

### CROSS REFERENCE TO RELATED APPLICATIONS

This application is the U.S. National Stage of International Application No. PCT/DE03/00612, filed Feb. 25, 2003 and claims the benefit thereof. The International Application claims the benefits of German application No. 10208748.2 filed Feb. 28, 2002, both of the applications are incorporated by reference herein in their entirety.

### FIELD OF INVENTION

This invention relates to a method, device and computer program for verifying the authenticity of non-electronic documents.

### BACKGROUND OF INVENTION

DE 199 33 731 A1 discloses a method for the form-independent and verifiable acknowledgement of the authorization of use with regard to service offerings, for example, transport services, hotel services and travel services or vehicle rentals. In this method, a key code is logged centralized and an individual code is assigned to the interested users, said users also being informed of its recall function. A coded authorization code is generated from the key code of a performance designation and the individual code and is communicated to the interested users, said users being informed of its recall function, for example, in a non-electronic, self-prepared document. If the key code and the individual code are present, the performance designation can be re-established from the authorization code.

To acknowledge the authorization of use, DE 199 33 731 A1 discloses a method for verifying the consistency of the original performance designation and the re-established performance designation. This verification is carried out in particular by the checking staff of transport companies, hotels, tour operators, rental car businesses or the like by means of corresponding checking devices. Therefore, the verification is based, in particular, on an optical comparison of the original and the re-established performance designation by means of the checking staff. As a result, a comparison of this kind is sometimes time-consuming and particularly error-prone if the checking staff is under pressure. In the case of more extensive performance designations, more costly display units must be provided for checking devices.

### SUMMARY OF INVENTION

The object of the present invention is to create a method for verifying the authenticity of non-electronic documents that can be implemented in a simple manner and is less error-prone, and to specify a device and computer program suitable therefor.

The object is achieved by the claims. Advantageous further developments of the invention are specified in the dependent claims.

A non-electronic document according to the-invention is used having a document identifier, text information and/or graphic user information, at least implicit information about the user of the document and a signature. The signature is a coded first test code calculated by means of a selected test function from the document identifier and the text information and/or graphic user information. The document identifier, the text information and/or graphic user information and the signature are scanned and a second test code is calculated from the scanned document identifier and the scanned text information and/or graphic user information by means of the selected test function. The scanned signature is decoded in order to determine the first test code by using the at least implicit information about the user of the document. Finally, the first and second test codes are compared for consistency. A comparison of this type can be automated and carried out without interaction from the checking staff. Furthermore, based on this and irrespective of the information contents of the text information and/or graphic user information, costly display devices for possible control units are not required.

### BRIEF DESCRIPTION OF THE DRAWINGS

Exemplary embodiments of the invention are detailed below with reference to the drawings in which;

FIG. 1 shows a schematic representation of an application scenario when verifying bank transfer forms and

FIG. 2 shows a schematic representation of an application scenario when checking personal identity cards or driving licenses.

### DETAILED DESCRIPTION OF INVENTION

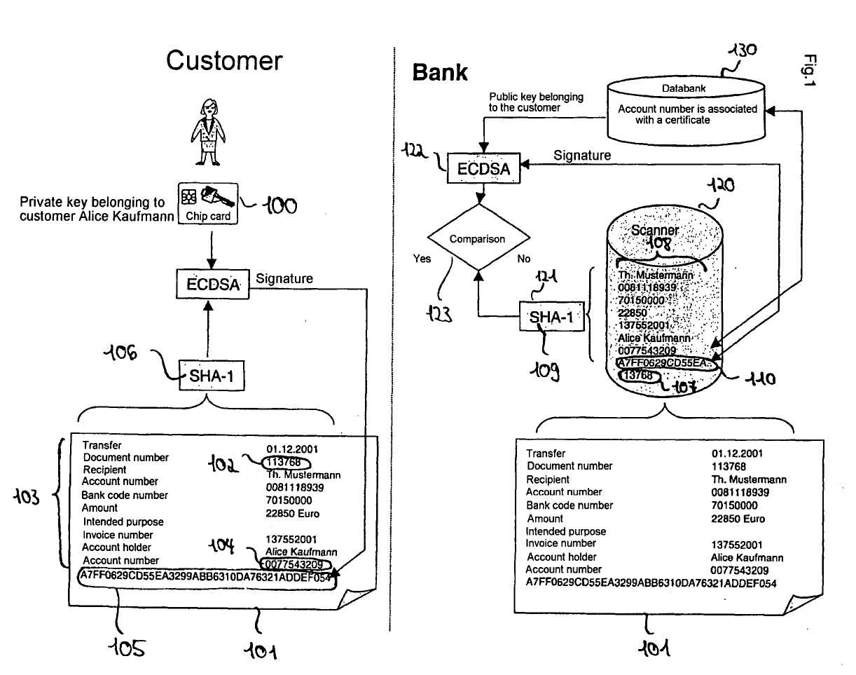

In the application scenario shown in FIG. 1, a customer of a bank has a chip card 100 whereon a private key is stored for an asymmetrical coding method. When the customer issues a bank transfer form 101, the bank transfer form 101 is provided with a document number 102, transaction-relevant text information 103, an account number 104 and a signature 105. Thus, the document number 102 represents a document identifier which serves to ensure that a bank transfer form 101 issued by the customer is only used once. The account number 104 contains implicit information about the issuer of the bank transfer form 101, namely the customer. By means of a selected test function, a first test code 106 is calculated from the document number 102 and the transaction-relevant text information 103.

This kind of test function is for example represented by the hash function that serves to reduce the calculating costs when coding data in the public key method. It is only the first test code 106 which is coded in order to reduce the calculating costs when coding, and not all the transaction-relevant text information 103. In this way, signature 105 is generated which is also printed on the bank transfer form 101. Signature 105 is generated for example by means of a DSA variant (digital signature algorithm) based on elliptical curves (ECDSA).

When a bank verifies the authenticity, the bank transfer form 101 is scanned in at a verification device, said verification device having a scanning device 120, a calculation device 121, a decoding device 122 and a comparison device 123. Furthermore, a database 130 is connected to the verification device; said database storing the public key of the bank customers. A second test code 109 is determined in the calculating device 121 from the scanned document number 107 and the scanned transaction-relevant text information 108 by means of the selected test function.

By using the account number as implicit information about the issuer of the bank transfer form 101, the scanned signature 110 is decoded in order to determine the first test code in the decoding device 122. Finally, the first test code 106 and the second test code 109 are compared for consistency in the comparison device 123. In the case of a positive verification result, the authenticity of the bank transfer form 101 is assured.

The aforementioned method for verifying the authenticity of the bank transfer form 101 is implemented by means of a computer program that can be loaded into the main memory of a data processing system not explicitly shown in FIG. 1, having code sections for the embodiment of which the above-mentioned steps are carried out if the computer program runs in the data processing system.

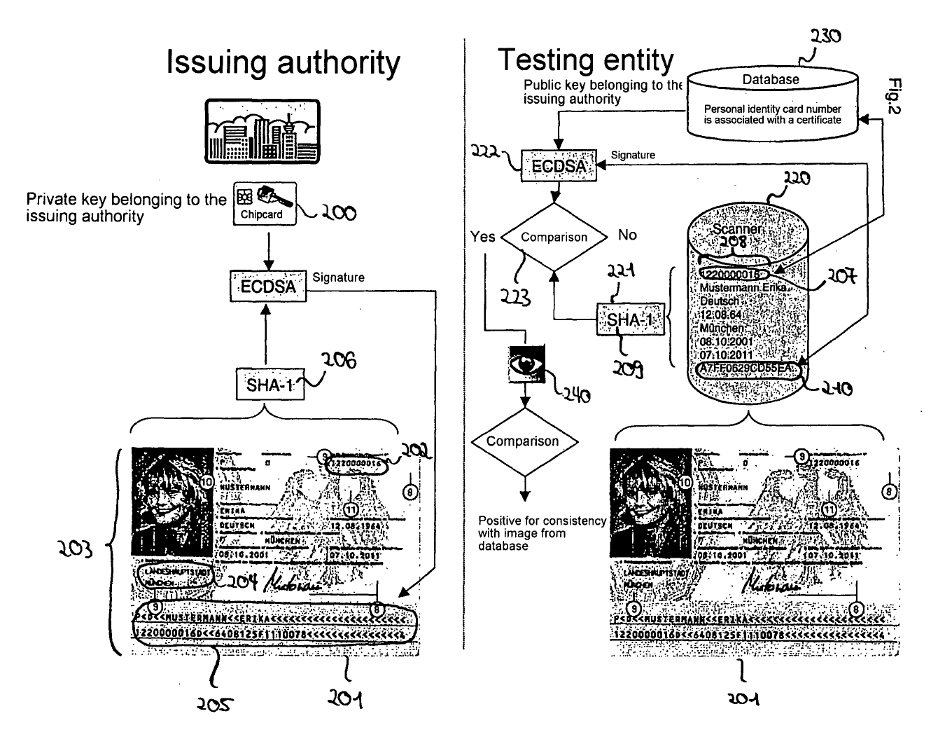

In the application scenario shown in FIG. 2, the authenticity of non-electronic documents issued by an authority is verified, for example personal identity cards or driver licenses. In this application scenario, the verification of the authenticity of personal identity cards is specifically explained. A personal identity card 201 has a personal identity card number 202 as the document identifier, personal text information and graphic information 203 and information 204 about the issuing authority and a signature 205.

A first test code 206 is calculated from the personal identity card number 202 and the person-related text information and graphic information 203 by means of a selected test function. Signature 205 is generated by coding this first test code 206 by means of an asymmetrical coding method. In order to code the first test code 206, the issuing authority has a chip card 200 on which the private key of the issuing authority is stored.

In order to verify the authenticity, the personal identity card 201 is scanned in a verification device. The verification device has a scanning device 220, a calculation device 221, a decoding device 222 and a comparison device 223. A second test code 209 is calculated in the calculation device 221 from the scanned personal identity card number 207 and the scanned person-related text information and graphic information 208 by means of the selected test function. In the decoding device 222, the scanned signature 210 is decoded to determine the first test code by using the information about the issuing authority. Subsequently, the first test code 206 and the second test code 209 are compared for consistency in the comparison device 223. In the case of a positive verification result, the authenticity of the personal identity card 201 is acknowledged.

When decoding the scanned signature 210, the verification device accesses public keys that are stored in a database 230 which can be accessed by said verification device. In order not to be at the mercy of a known signature attack, not only the person-related text information and graphic information is signed, but also the public key of the issuing authority. This is stored as a key object on the personal identity card and can therefore no longer be read out. Therefore, on the basis of its unknown size, a hacker can no longer search the entire PIN space until the appropriate private key has been found. Only the manufacturer of the personal identity card, for example, the certification authority (CA) has the corresponding certificates in the repository and is therefore able to verify the signatures. The repository can only be accessed via a stringent authentication and coding.

In the case of the application scenario for verifying the authenticity of a personal identity document, the biometric data of the holder of the personal identity card is output to a control unit not shown in FIG. 2 to be compared with the person presenting the personal identity card. In the simplest case, this takes place by displaying an image representing the holder of the personal identity card.

The aforementioned method for verifying the authenticity of non-electronic documents is not only limited to the above-mentioned application scenarios. In this manner, an application scenario can also be used in which the method according to the invention for checking tickets on trains would also be possible. The tickets within the framework of an online booking were for example prepared by the specific passengers themselves. A symmetrical coding method should be used to avoid the need for a control unit, carried along by the train staff, to be continuously connected to a database with key information. A corresponding central coding code that was used for issuing the specific ticket is also logged in the control unit.

1-8. (canceled)

9. A method for verifying the authenticity of non-electronic documents, comprising:
providing a document identifier, text information and/or graphic user information, at least implicit information about the issuer of the document, and a signature for a non-electronic document, wherein the signature is a coded first test code calculated from the document identifier and the text information and/or graphic user information by a test function;
scanning the document identifier, the text information and/or graphic user information and the signature;
calculating a second test code from the scanned document identifier and the scanned text information and/or graphic user information by the test function;
decoding the scanned signature to determine the first test code by using the at least implicit information about the issuer of the document; and
comparing the first and second test codes for consistency.

10. The method according to claim 9, wherein the first test code and the scanned signature are coded or decoded by an asymmetrical coding method.

11. The method according to claim 9, wherein the first test code and the scanned signature are coded or decoded by a symmetrical coding method.

12. The method according to claim 9, wherein the document identifier, the text information and/or graphic user information and/or the signature are scanned optically.

13. The method according to claim 10, wherein the document identifier, the text information and/or graphic user information and/or the signature are scanned optically.

14. The method according to claim 11, wherein the document identifier, the text information and/or graphic user information and/or the signature are scanned optically.

15. The method according to claim 9, wherein at a control unit, the biometric data of a person that is assigned to the document by the document identifier, the text information and/or the graphic user information and/or the at least implicit information about the user of the document is indicated and/or issued in comparison with the person who hands over the document and/or carries it on him/her.

16. The method according to claim 10, wherein at a control unit, the biometric data of a person that is assigned to the document by the document identifier, the text information and/or the graphic user information and/or the at least implicit information about the user of the document is indicated and/or issued in comparison with the person who hands over the document and/or carries it on him/her.

17. The method according to claim 11, wherein at a control unit, the biometric data of a person that is assigned to the document by the document identifier, the text information and/or the graphic user information and/or the at least implicit information about the user of the document is indicated and/or issued in comparison with the person who hands over the document and/or carries it on him/her.

18. The method according to claim 12, wherein at a control unit, the biometric data of a person that is assigned to the document by the document identifier, the text information and/or the graphic user information and/or the at least implicit information about the user of the document is indicated and/or issued in comparison with the person who hands over the document and/or carries it on him/her.

19. The method according to claim 15, wherein an image representing a person assigned to the document is displayed on the control unit.

20. The method according to claim 9, wherein the method is performed by a computer program.

21. The method according to claim 20, wherein the computer program is stored on a data medium, floppy disk, CD or DVD.

22. The method according to claim 20, wherein the computer program is installed on a data processing unit.

23. A device for verifying the authenticity of non-electronic documents having a document identifier, a text information and/or a graphic user information, at least implicit information about the issuer of the document and a signature which is a coded first test code calculated by a test function from the document identifier and the text information and/or graphic user information, the device comprising:
a scanning device for detecting the document identifier, the text information and/or graphic user information and the signature;
a calculating device to determine a second test code from the scanned document identifier and the scanned text and/or graphic user information by the test function;
a decoding device to determine the first test code by using the at least implicit information about the user of the document from the scanned signature; and
a comparison device to determine the consistency between the first and the second test codes.
